(19) United States
(12) Patent Application Publication
(10) Pub. No.: US 2009/0013328 A1
(43) Pub. Date: Jan. 8, 2009

(54) CONTENT SWITCHING PROGRAM, CONTENT SWITCHING METHOD, AND CONTENT MANAGEMENT APPARATUS

(75) Inventors: Toshifumi Masuko, Kawasaki (JP); Syouichi Kamio, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/212,192

(22) Filed: Sep. 17, 2008

Related U.S. Application Data
(63) Continuation of application No. PCT/JP2006/305876, filed on Mar. 23, 2006.

(51) Int. Cl. G06F 9/46; G06F 15/167

(52) U.S. Cl. 718/105; 709/226

(57) ABSTRACT

A computer-readable storage medium on which is recorded a content switching program used to direct a device for transmitting a content corresponding to data to a requester in response to a data acquire request from the requester to perform a content switching process, the process comprising: a load acquiring step of acquiring a load on the device; a content selecting step of selecting, on the basis of the acquired load, one of a plurality of contents that can be a content to be transmitted and each of which has a different volume; and a storage location changing step of changing a storage location of the content to be transmitted into a storage location of the selected content.

### CROSS REFERENCE TO RELATED APPLICATION

This application is a continuation of PCT application of PCT/JP2006/305876, which was filed on Mar. 23, 2006.

### BACKGROUND OF THE INVENTION

1. Field of the Invention

The present invention relates to a content switching program, a content switching method, and a content management apparatus having the content switching function.

2. Description of the Related Art

When contents are displayed on the terminal of a client, a Web browser of the client requests a Web server to transmit data, receives the corresponding data from the Web server, and displays the data on the client side.

However, when a disaster such as an earthquake etc. takes place, access can be temporarily concentrated. Under such conditions, the loads of a Web server and a network become high, and it takes a long time for data to reach all clients who have requested the data.

To avoid the situation, the patent document 1 discloses the technology of determining the load status of a Web server and the load status of a network on the client (Web browser) side, and requests the Web server to provide data with normally displayed data partially omitted when the load status is high.

However, in the technology of the patent document 1, data communication is required to measure the load of the Web server or the load of the network. The redundant data communication imposes a load on the Web server and the network.

Patent Document 1: Japanese Published Patent Application No. 2004-21365 “Method for Selecting Contents to be Received”

### SUMMARY OF THE INVENTION

The present invention aims at providing a content switching program, a content switching method, and a content management apparatus capable of reduce the load of a device when data acquire requests are temporarily concentrated.

The content switching program according to the first aspect of the present invention allows a device for transmitting a content corresponding to data to a requester in response to a data acquire request from the requester to perform a content switching process. The process includes: a load acquiring step of acquiring a load on the device; a content selecting step of selecting, on the basis of the acquired load, one of a plurality of contents that can be a content to be transmitted and each of which has a different volume; and a storage location changing step of changing a storage location of the content to be transmitted into a storage location of the selected content.

On the basis of the load on the device, the storage location of the content to be transmitted is changed. Therefore, for example, if a content of a smaller volume is selected from among the plurality of contents when the load on the device becomes heavier, and the selected content is transmitted, then the load on the device can be reduced when data acquire requests are temperature concentrated.

The content switching method according to the second aspect of the present invention allows a device for transmitting a content corresponding to data to a requester in response to a data acquire request from the requester to perform a content switching process. The method includes: a load acquiring step of acquiring a load on the device; a content selecting step of selecting, on the basis of the acquired load, one of a plurality of contents that can be a content to be transmitted; and a storage location changing step of changing a storage location of the content to be transmitted into a storage location of the selected content.

The content management apparatus according to the third aspect of the present invention transmits a content corresponding to data to a requester in response to a data acquire request from the requester. The apparatus includes: a load acquisition unit for acquiring a load on the device; a content selecting unit for selecting, on the basis of the acquired load, one of a plurality of contents that can be a content to be transmitted; and a storage location directory changing unit for changing a storage location of the content to be transmitted into a storage location of the selected content.

According to the present invention, when data acquire requests are temperature concentrated, the load on a device can be reduced.

### BRIEF DESCRIPTION OF THE DRAWINGS

FIG. 1 shows the configuration of the content switching unit according to an embodiment of the present invention;

FIG. 2 is a block diagram of the configuration of the content management apparatus (Web server device) provided with the content switching unit shown in FIG. 1;

FIG. 3 shows the storage areas of a plurality of contents set for certain contents in a content storage area;

FIG. 4 shows an example of displaying rich contents, still image and text version contents, text only version contents, and minimal information version contents;

FIG. 5 shows an example of a code corresponding to a logic built in the content switching unit (device load acquisition unit and storage location directory changing unit);

FIG. 6 is a table showing an example of a selection logic built in the content selecting unit;

FIG. 7 is a flowchart of the process of selecting a content to be transmitted to a client; and

FIG. 8 shows an example of a storage medium.

### DESCRIPTION OF THE PREFERRED EMBODIMENTS

The embodiments of the present invention are described below in detail with reference to the attached drawings.

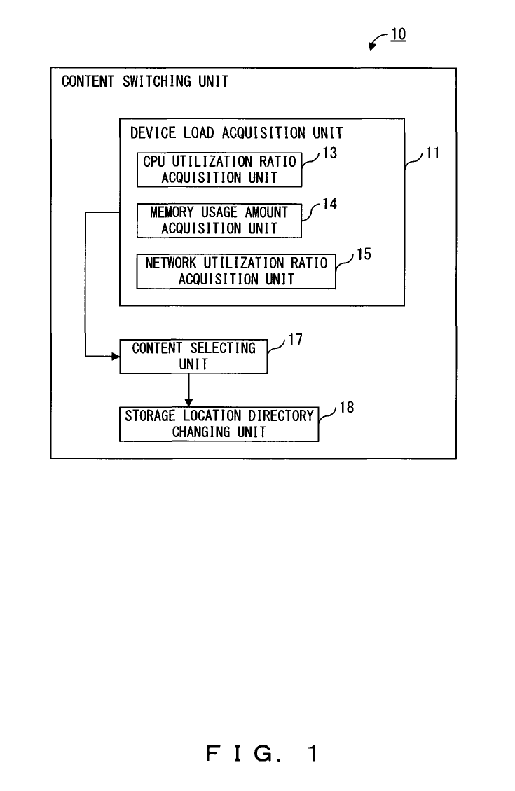

FIG. 1 shows the configuration of the content switching unit according to an embodiment of the present invention. The content switching unit is built in the Web server device (not shown in the attached drawings) for transmitting to a client a content corresponding to data in response to a data (Web page, URL) acquire request from the client.

As shown in FIG. 1, a content switching unit 10 includes a device load acquisition unit 11 for acquiring a load on the Web server device, a content selecting unit 17 for selecting, on the basis of the acquired load, one of a plurality of contents that can be transmitted and have respective different volumes; and a storage location directory changing unit 18 for changing a storage location directory of a content to be transmitted into a storage location directory of the selected content.

The device load acquisition unit 11 includes a CPU (central processing unit) utilization ratio acquisition unit 13, a memory usage amount acquisition unit 14, and a network utilization ratio acquisition unit 15.

A CPU utilization ratio is a ratio of busy to wait of the CPU in view of a certain time interval. An amount of memory usage is a ratio of a memory area being used to the entire memory area managed by the OS. A network utilization ratio is an I/O usage rate of a network adapter.

For example, the CPU utilization ratio acquisition unit 13, the memory usage amount acquisition unit 14, and the network utilization ratio acquisition unit 15 are realized by a function prepared by the operating system (OS) or a utility.

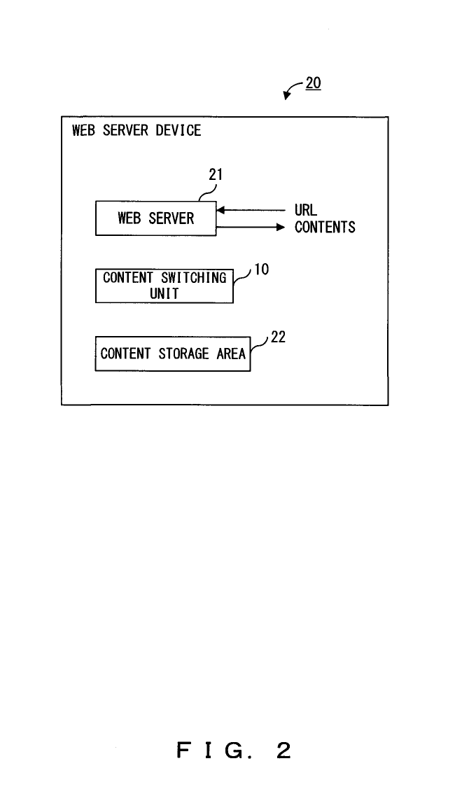

FIG. 2 is a block diagram of the configuration of the content management apparatus (Web server device) provided with the content switching unit shown in FIG. 1.

In the following descriptions, the “Web server device” refers to a device having a content managing function as hardware, the “Web server” refers to a function block provided for the Web server device, inputs a URL (uniform resource locator) from a client and outputs a content corresponding to the URL.

As shown in FIG. 2, a content management apparatus (Web server device) 20 comprises a Web server 21, the content switching unit 10, and a content storage area 22.

The content storage area 22 has a plurality of directories for storing a plurality of contents under a directory of a content to be transmitted so that the plurality of contents that can be transmitted to a client can be stored.

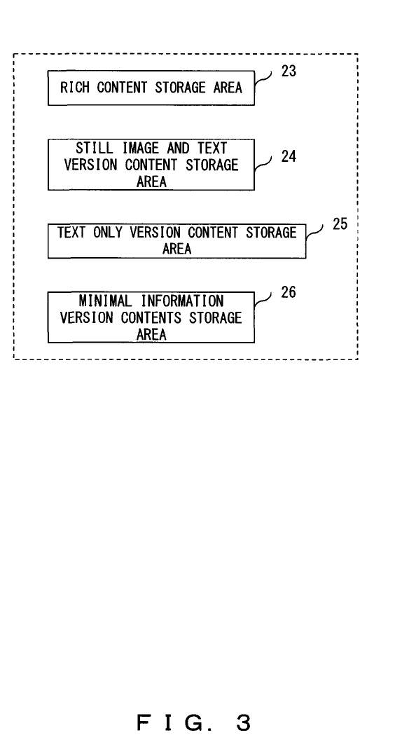

FIG. 3 shows the storage areas of a plurality of contents set for certain contents in the content storage area 22.

There are four types of contents as shown in FIG. 3. They are: “rich contents” including animation (such as FLASH, GIF (graphics interchange format) etc.) in addition to text and image data; “still image and text version contents” configured by still images and text with the animation removed from the rich contents; “text only version contents” configured by only text with the animation and image data removed from the rich contents; and “minimal information version contents” configured by text as minimal information only.

That is, set for the contents in the content storage area 22 are a rich content storage area 23, a still image and text version content storage area 24, a text only version content storage area 25, and a minimal information version contents storage area 26. As for the volume, the “rich contents” are the largest sequentially followed by the “still image and text version contents”, the “text only version contents”, and the “minimal information version contents” in the descending order.

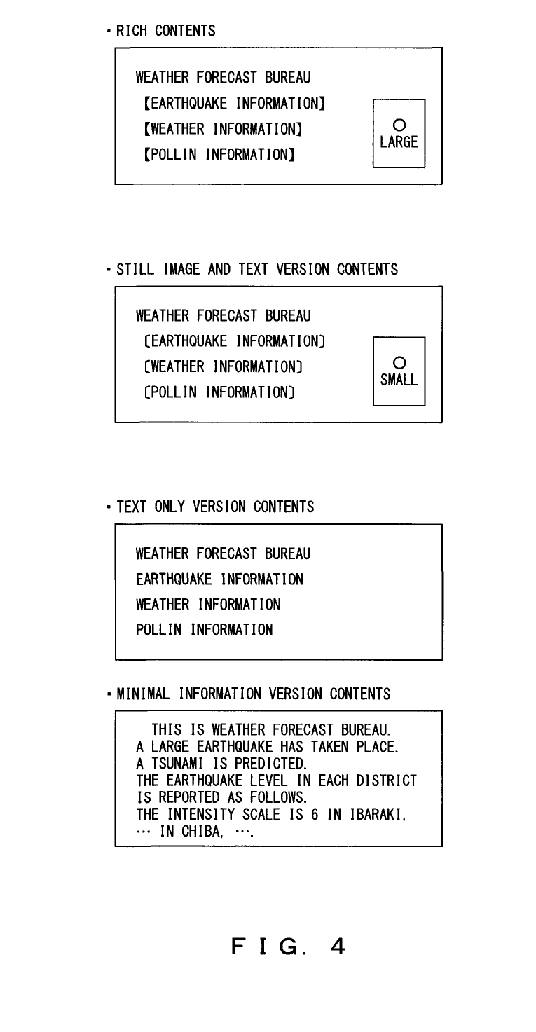

FIG. 4 shows an example of displaying rich contents, still image and text version contents, text only version contents, and minimal information version contents.

As necessary, the “still image and text version contents” and the “text only version contents” can be automatically generated from the “rich contents”.

The content switching process performed by the content switching unit 10 is described below.

The contents on the Web server device are managed for each directory corresponding to the URL.

For example, assuming that the URL requested by the Web browser of a client is “http://fujitsu.com/index.html”, and the directory of the Web server device corresponding to the URL is “/var/httpd/htdocs/”, the Web server transmits to the client a content (/var/httpd/htdocs/index.html) corresponding to the URL under the directory (/var/httpd/htdocs/). In asynchronization with the content transmitting process by the Web server, the content switching unit 10 performs a process of changing a reference location directory to refer to a directory other than the specified directory (/var/httpd/htdocs/).

For example, under the specified directory (“/var/httpd/htdocs/”), the following four directories are prepared, and the content switching unit 10 changes the reference location (storage location of a html file) directory so that one of the directories can be referred to.

/var/httpd/htdocs/rich/ . . . rich contents storage location directory

/var/httpd/htdocs/picture_text/ . . . still image and text version contents storage location directory

/var/httpd/htdocs/text/ . . . text only version contents storage location directory

/var/httpd/htdocs/minimum_info/ . . . minimal information version contents storage location directory

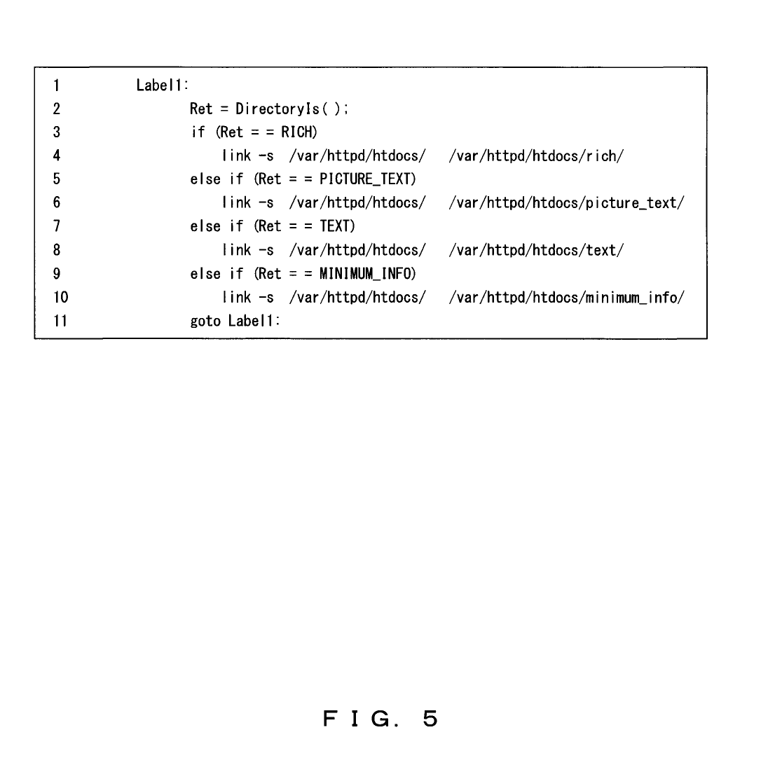

FIG. 5 shows an example of a code corresponding to a logic built in the content switching unit 10 (device load acquisition unit 11 and storage location directory changing unit 12).

In FIG. 5, “Label1:” in line 1 indicates the starting position of an endless loop. “DirectoryIs( )” in line 2 indicates a function of selecting a content storage location directory. The function, corresponding to the combination of the device load acquisition unit 11 and the content selecting unit 17, selects the storage location directory of the content on the basis of each acquired load (CPU utilization ratio, amount of memory usage, network utilization ratio) of the device. The selected storage location directory is set in the variable “Ret” storing the return value of the function.

In the “if statement” in line 3 to 10, a process of changing the storage location directory of the content is performed depending on the return value “Ret”.

In FIG. 5, the “link statement” in lines 4, 6, 8, and 10 has the following format.

link -s directory 1 directory 2

After the “link statement” is executed, for example, if the Web server 21 specifies the “directory 1” as a reference location, the reference location (“directory 1”) is changed into the “directory 2”. That is, the Web server 21 transmits, for example, html file below the “directory 2” to the client. The “link statement” corresponds to a function of the symbolic link known as one of the switching methods of specified reference locations, and is realized by a function prepared by the OS or a utility.

For example, in line 3 shown in FIG. 5, when it is determined that the return value of the function “DiretoryIs( );” is “Rich (use rich contents)”, the “link statement” is used, and the content storage location directory (/var/httpd/htdocs/) is changed into a directory storing rich contents (/var/httpd/htdocs/rich/).

In line 11 shown in FIG. 5, the “go to statement” returns control to the leading line. That is, the content switching unit 10 of the present embodiment performs the loop process shown in FIG. 5.

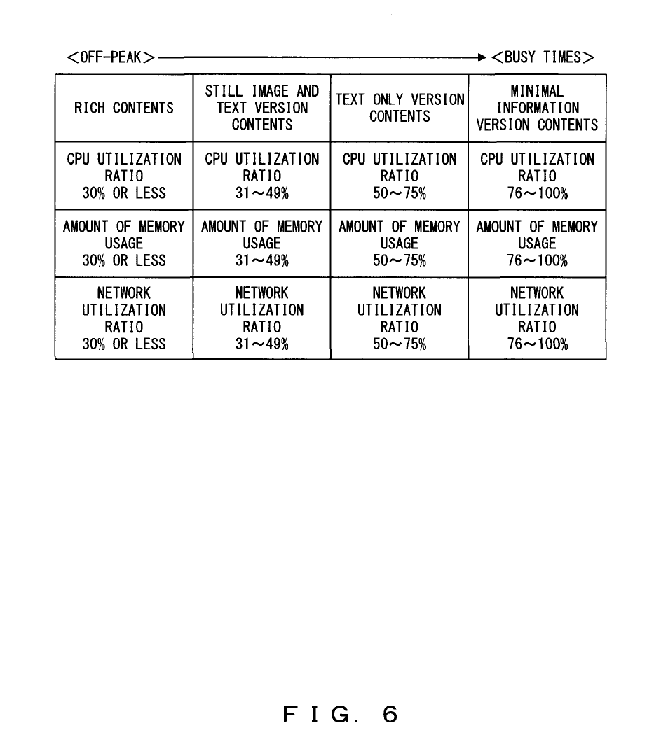

FIG. 6 is a table showing an example of a selection logic built in the content selecting unit 18.

In the table shown in FIG. 6, the content to be transmitted to the client is selected.
If the CPU utilization ratio is 30% or less, the amount of memory usage is 30% or less, and the network utilization ratio is 30% or less, then the “rich contents” are selected as contents to be transmitted to the client.
When the largest value of the CPU utilization ratio, the amount of memory usage, and the network utilization ratio is in the range from 31% to 49%, the “still image and text version contents” are selected as the contents to be transmitted to the client.
When the largest value of the CPU utilization ratio, the amount of memory usage, and the network utilization ratio is in the range from 50% to 75%, the “text only version contents” are selected as the contents to be transmitted to the client.
When the largest value of the CPU utilization ratio, the amount of memory usage, and the network utilization ratio is in the range from 76% to 100%, the “minimal information version contents” are selected as the contents to be transmitted to the client.

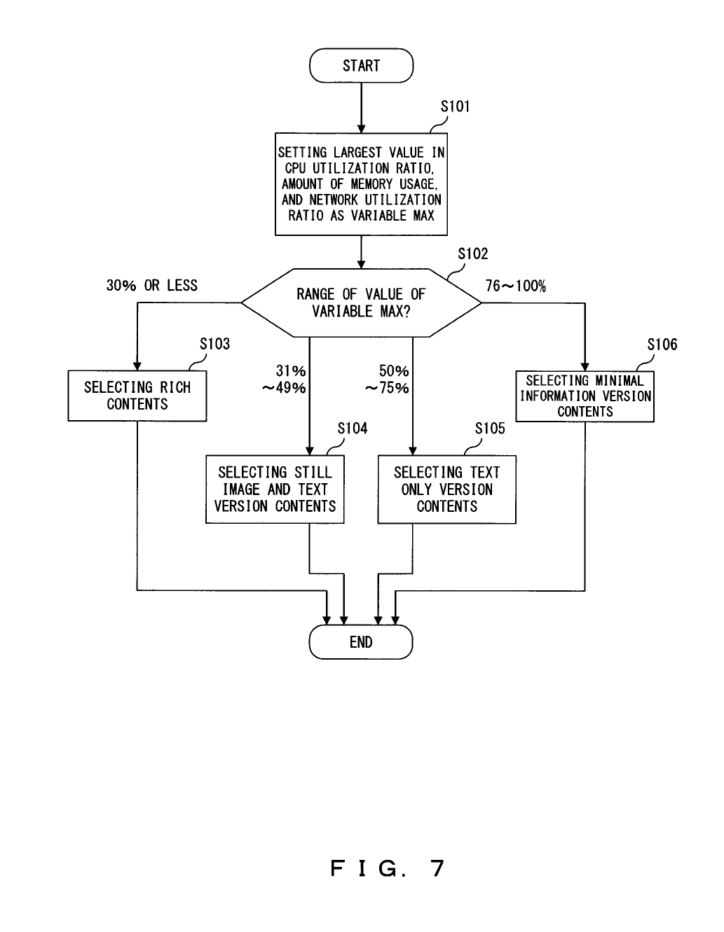

FIG. 7 is a flowchart of the process of selecting a content to be transmitted to a client. The process of the flowchart is performed by the content selecting unit 17 shown in FIG. 2.

In FIG. 7, first in step S101, the largest value of the CPU utilization ratio, the amount of memory usage, and the network utilization ratio acquired at the time is set as a variable MAX indicating the maximum load at the time. Then, in step S102, the range to which the value of the variable MAX is determined. If it is determined in step S102 that the variable MAX is 30% or less, then the “rich contents” are selected as contents to be transmitted to the client in step S103, and a series of processes are terminated.

If it is determined in step S102 that the variable MAX is in the range from 31% to 49%, then the “still image and text version contents” are selected as contents to be transmitted to the client in step S104, and a series of processes are terminated.

If it is determined in step S102 that the variable MAX is in the range from 50% to 75%, then the “text only version contents” are selected as contents to be transmitted to the client in step S105, and a series of processes are terminated.

If it is determined in step S102 that the variable MAX is in the range from 76% to 100%, then the “minimal information version contents” are selected as contents to be transmitted to the client in step S106, and a series of processes are terminated.

In the descriptions above, the cases in which access is temporarily concentrated on a Web server device when a disaster takes place are described. However, it is obvious that the content switching technology is useful also in other cases when access is concentrated on the Web server device.

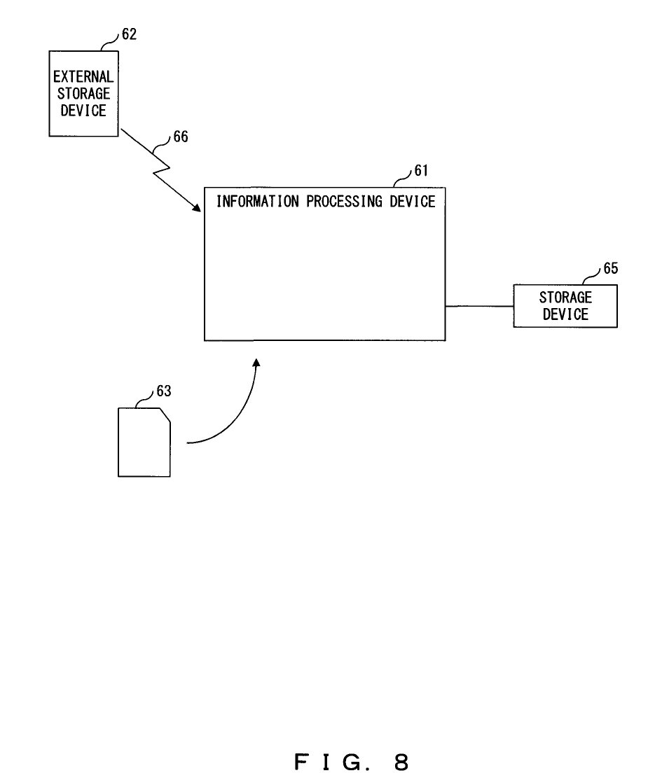

FIG. 8 shows an example of a storage medium.

The content switching process according to the present invention can be realized by an information processing device 61. The program and data for performing the process according to the present invention can be performed by being loaded into memory of the information processing device 61 from a storage device 65 of the information processing device 61, by being loaded into the memory of the information processing device 61 from a portable storage medium 63, or by being loaded into the memory of the information processing device 61 from an external storage device 62 over a network 66.

What is claimed is:

1. A computer-readable storage medium on which is recorded a content switching program used to direct a device for transmitting a content corresponding to data to a requester in response to a data acquire request from the requester to perform a content switching process, the process comprising:
a load acquiring step of acquiring a load on the device;
a content selecting step of selecting, on the basis of the acquired load, one of a plurality of contents that can be a content to be transmitted and each of which has a different volume; and
a storage location changing step of changing a storage location of the content to be transmitted into a storage location of the selected content.

2. The computer-readable storage medium according to claim 1, wherein
the content is switched in asynchronization with a data acquire request from the requester.

3. The computer-readable storage medium according to claim 1, wherein
when the load on the device becomes heavier, a content of a smaller volume is selected from among the plurality of contents.

4. A content switching method used to direct a device for transmitting a content corresponding to data to a requester in response to a data acquire request from the requester to perform a content switching process, the process comprising:
a load acquiring step of acquiring a load on the device;
a content selecting step of selecting, on the basis of the acquired load, one of a plurality of contents that can be a content to be transmitted and each of which has a different volume; and
a storage location changing step of changing a storage location of the content to be transmitted into a storage location of the selected content.

5. The method according to claim 4, wherein
the content is switched in asynchronization with a data acquire request from the requester.

6. The method according to claim 4, wherein
when the load on the device becomes heavier, a content of a smaller volume is selected from among the plurality of contents.

7. A content management apparatus which transmits a content corresponding to data to a requester in response to a data acquire request from the requester, comprising:
a load acquisition unit for acquiring a load on the device;
a content selecting unit for selecting, on the basis of the acquired load, one of a plurality of contents that can be a content to be transmitted and each of which has a different volume; and
a storage location directory changing unit for changing a storage location of the content to be transmitted into a storage location of the selected content.

8. The apparatus according to claim 7, wherein
the load is acquired, the content is selected, and a content storage location is changed in asynchronization with the data acquire request from the requester.

9. The apparatus according to claim 7, wherein
when the load on the device becomes heavier, a content of a smaller volume is selected from among the plurality of contents.
